(19) United States
(12) Patent Application Publication
(10) Pub. No.: US 2013/0088395 A1
(43) Pub. Date: Apr. 11, 2013

(54) METHOD AND APPARATUS FOR ESTIMATING DIRECTION OF ARRIVAL

(71) Applicant: Mikko Olavi Vaarakangas, Espoo (FI)

(72) Inventor: Mikko Olavi Vaarakangas, Espoo (FI)

(73) Assignee: NOKIA CORPORATION, Espoo (FI)

(21) Appl. No.: 13/805,301

(22) PCT Filed: Jun. 19, 2010
(86) PCT No.: PCT/IB2010/001490

§ 371 Date: Dec. 18, 2012

(51) Int. Cl. G01S 3/46

(52) U.S. Cl. CPC G01S 3/46
USPC 342/378

(57) ABSTRACT

In accordance with an example embodiment of the present invention, an apparatus, comprising a receiver configured to receive a first portion of a radio signal comprising a time redundant portion received at a first antenna and a second portion of the radio signal received at a second antenna, a correlator configured to determine a value of correlation between the first portion and the second portion and a processor configured to estimate direction of arrival of the radio signal based at least in part upon the value of correlation.

### TECHNICAL FIELD

The present application relates generally to estimation of direction of arrival.

### BACKGROUND

Positioning of radio transmitters, also known as direction of arrival (DoA) estimation or angle of arrival estimation, is a field of knowledge that aims to determine the direction of a wireless transmitter with respect to a wireless receiver.

Many techniques exist in the art for DoA estimation and most of these techniques involve receiving the signals transmitted by the wireless transmitter whose direction needs to be estimated, by an array of antennas and processing these signals to determine the DoA. Further, DoA estimation techniques that use antenna arrays can be broadly classified into two categories: ones that require each antenna in the array to have its own receiver and ones that allow one or more antennas in the array to share a receiver.

### SUMMARY

Various aspects of examples of the invention are set out in the claims.

According to a first aspect of the present invention, an apparatus, comprising a receiver configured to receive a first portion of a radio signal comprising a time redundant portion received at a first antenna and a second portion of the radio signal received at a second antenna, a correlator configured to determine a value of correlation between the first portion and the second portion and a processor configured to estimate direction of arrival of the radio signal based at least in part upon the value of correlation.

According to a second aspect of the present invention, a method, comprising determining correlation between a first portion of a radio signal comprising a time redundant portion received at a first antenna and a second portion of the radio signal received at a second antenna and estimating direction of arrival of the radio signal based at least in part on the correlation.

According to a third aspect of the present invention, a computer program, comprising code for determining correlation between a first portion of a radio signal comprising a time redundant portion received at a first antenna and a second portion of the radio signal received at a second antenna and code for estimating direction of arrival of the radio signal based at least in part on the correlation, when the computer program is run on a processor.

### BRIEF DESCRIPTION OF THE DRAWINGS

For a more complete understanding of example embodiments of the present invention, reference is now made to the following descriptions taken in connection with the accompanying drawings in which:

FIG. 1 illustrates propagation of radio signals through a wireless medium;

FIG. 2 shows an antenna array that is located far enough from the radio transmitter for a plane wave assumption to hold;

FIG. 3 shows an example orthogonal frequency division multiplexing symbol;

FIG. 4(a) shows how OFDM symbols such as one described in FIG. 3 are received by an antenna array according to an example embodiment of the invention;

FIG. 4(b) shows how a generic radio signal employing time domain redundancy is received by an antenna array according to an example embodiment of the invention;

FIG. 5 shows an apparatus for estimating direction of arrival of a radio signal according to an example embodiment of the invention; and

FIG. 6 is a flowchart for showing operations for estimating direction of arrival according to an example embodiment of the invention.

### DETAILED DESCRIPTION OF THE DRAWINGS

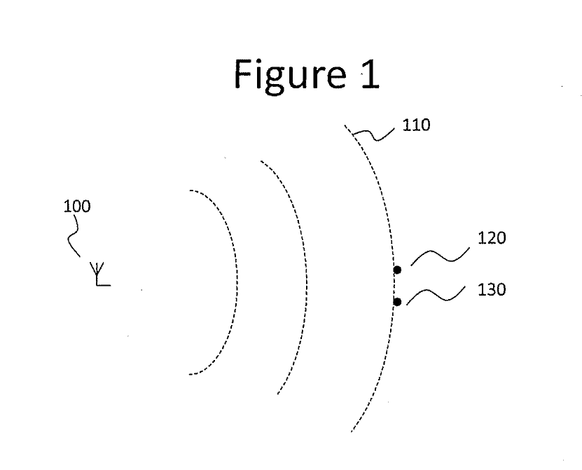

An example embodiment of the present invention and its potential advantages are understood by referring to FIGS. 1 through 6 of the drawings.

FIG. 1 demonstrates propagation of radio signals through the wireless medium. Radio signals are electromagnetic waves that propagate through the wireless medium at the speed of light. Radio waves emanated from a radio transmitter 100 may spread out spherically such that each point on a sphere has the same phase. At a far enough location from the radio transmitter, the radius of a sphere 110 may become large enough such that two points 120 and 130 on the surface of the sphere can be assumed to lie on a plane. In an example embodiment, this assumption is called the plane wave assumption.

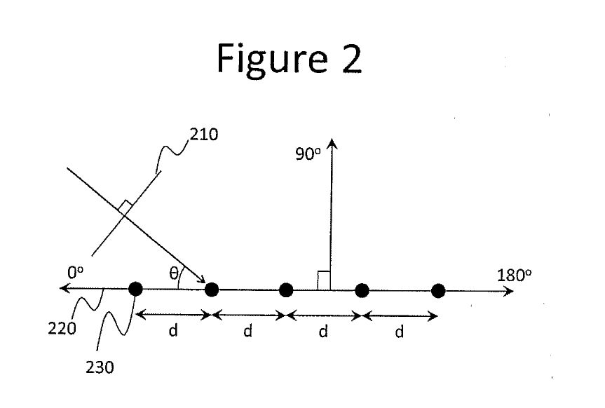

FIG. 2 shows an antenna array 220 that is located far enough from a radio transmitter, for example radio transmitter 100 of FIG. 1, for the plane wave assumption to hold. The antenna array 220 comprises a plurality of antennas 230, positioned along a line and separated by distance d. Plane wave 210 arrives at the antenna array 220 at an angle θ. Angle θ is said to be the angle of arrival or the direction of arrival (DoA) of the radio signals at the antenna array.

It should be noted that numerous other antenna array configurations can be used with the methods and apparatuses of the invention and the teachings of the invention do not require the antennas to be along a straight line or equally spaced.

Various embodiments of the invention utilize time domain redundancy in radio signals to determine their DoA. Communication systems may choose to implement time domain redundancy in their transmissions for various reasons, most common among which is to guard against distortions introduced by the wireless medium. Time domain redundancy may be introduced in a signal by copying a part of the signal and attaching it to the signal itself. A modulation technique that utilizes time domain redundancy by copying a part of the signal to itself is orthogonal frequency division multiplexing (OFDM). OFDM is currently used in many wireless communications systems, such as various IEEE 802.11 wireless local area network (WLAN) systems, Worldwide Interoperability for Microwave Access (WiMAX) systems, Long Term Evolution (LTE), etc. For the sake of discussion and not to limit the scope of the invention in any way, various embodiments of the invention are described with respect to systems complying with the IEEE Std. 802.11a-1999 standard for WLANs.

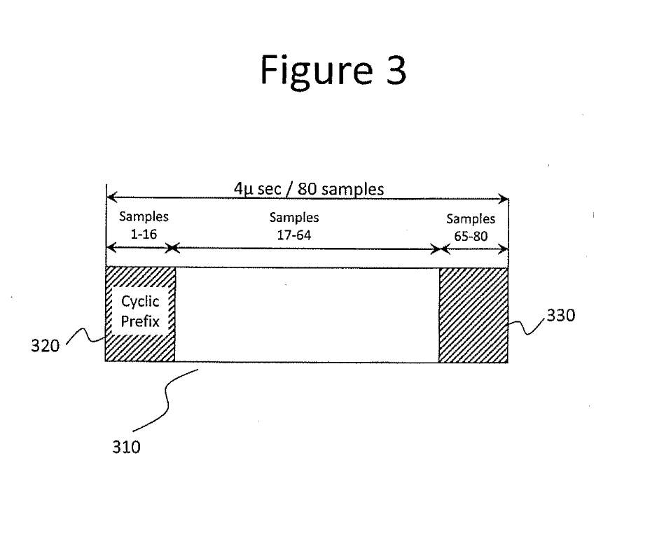

FIG. 3 shows an OFDM symbol as described in the IEEE Std. 802.11a-1999 standard. The IEEE Std. 802.11a-1999 standard defines a 4μ second long OFDM symbol 310 that contains a total of 80 samples. 64 of these samples, namely samples 17-80, are derived from the output of a Fast Fourier Transform. The last 16 samples, samples 65-80 630 of the OFDM symbol 310 are copied over to the beginning of the OFDM symbol as a cyclic prefix 320 to introduce time domain redundancy in the OFDM symbol to guard against inter symbol interference. Hence, for the OFDM symbol of FIG. 3, cyclic prefix is the time redundant portion and the last sixteen samples of the OFDM symbol constitute the part of the symbol from which the time redundant portion or cyclic prefix is derived. Also, the first sixteen samples 320 and the last sixteen samples 330 are shaded to indicate that these samples are identical.

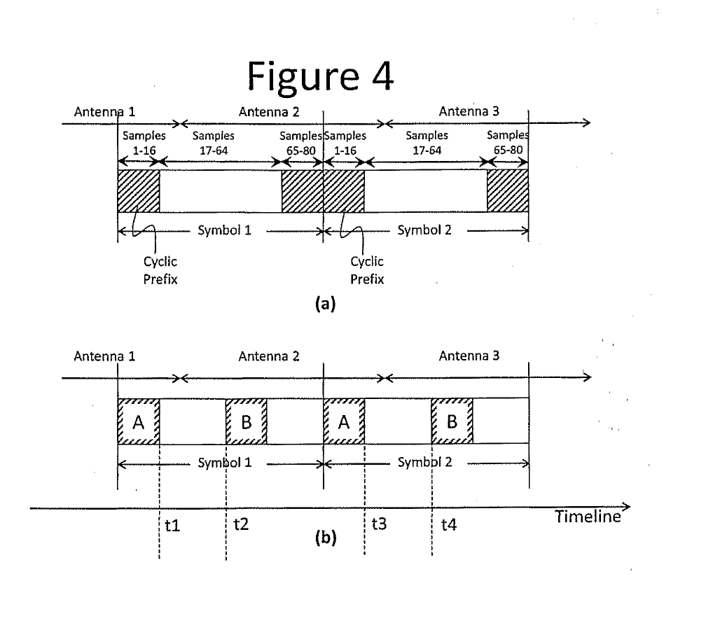

FIG. 4(a) shows how OFDM symbols, for example OFDM symbols 310 of FIG. 3, are received by an antenna array according to an example embodiment of the invention. In this example embodiment of the invention, the antennas in an antenna array share a single receiver and hence the antennas are switched according to a pattern so that the receiver may process the signal received by each antenna.

In accordance with an embodiment of the invention, antenna switching is performed such that the cyclic prefix of an OFDM symbol and the part of the OFDM symbol used to construct the cyclic prefix are received by different antennas.

As shown in FIG. 4(a), cyclic prefix of Symbol 1 is received from Antenna 1 by the receiver and then the receiver switches to Antenna 2. The switching occurs at a time that is after the cyclic prefix has been received by Antenna 1 but before the last 16 samples of the OFDM symbol are received by Antenna 1, i.e., the switching may occur anywhere from sample 17 to sample 64 of symbol 1. Due to the switching, last 16 samples of Symbol 1 are received by Antenna 2. Since the last 16 samples of Symbol 1 are the samples used to construct the cyclic prefix of Symbol 1, the phase difference between the samples of the cyclic prefix received by Antenna 1 and the last sixteen samples of Symbol 1 received by Antenna 2 is caused by the separation between the two antennas. This phase difference may be calculated by computing value of correlation between cyclic prefix received by Antenna 1 and last 16 samples of Symbol 1 received by Antenna 2 and extracting the phase of this complex valued correlation.

In an example embodiment of the invention, the antennas are switched in the middle of OFDM symbols. In this case, Antenna 1 will first receive samples 41-80 of symbol preceding Symbol 1, followed by samples 1-40 of Symbol 1. Similarly, Antenna 2 will receive samples 41-80 of Symbol 1 followed by samples 1-40 of Symbol 2. Hence, cyclic prefix of Symbol 1 will be contained in sample numbers 41-56 received by Antenna 1 and the last 16 samples of Symbol 1 will be contained in sample numbers 25-40 received by Antenna 2. Based upon this, the phase difference, φ_{2,1}, between Antenna 2 and Antenna 1 may be computed according to the following equation:

$${ϕ}_{2 , 1} = Angle ( {\sum }_{k = 1}^{16} {\{ Ant 2 ( 24 + k ) \}}^{*} \{ Ant 1 ( 40 + k ) \} )$$

where Ant1(i) denotes the sample received by Antenna 1, Ant2(i) denotes the i^{th} sample received by Antenna 2, { . . . }* denotes the complex conjugate operation, Angle ( . . . ) denotes the phase or the angle operator and k is a dummy variable that is used as index of summation. The above equation may be succinctly written as

φ_{2,1}=Angle(U^{H}V)

where U denotes a column vector comprising samples 25-40 received by antenna 2, V denotes a column vector comprising samples 41-56 received by antenna 1 and U^{H} is complex-conjugate transpose of the column vector U.

Given knowledge of wavelength, λ, of the radio signal, DoA may be calculated based upon angle of correlation. The DoA of the radio signal, θ, at Antenna 1 and Antenna 2 based upon φ_{2,1}, is given by:

$$θ = {Cos}^{- 1} ( \frac{{ϕ}_{2 , 1}}{2 π d / λ} )$$

where d is the distance between Antenna 1 and Antenna 2.

It should be noted that in FIG. 4(a), OFDM symbols are used just as an example to illustrate an embodiment of a very widely applicable method. The same principle can be utilized for any radio signal utilizing time domain redundancy.

FIG. 4(b) shows how a generic radio signal employing time domain redundancy is received by an antenna array according to an example embodiment of the invention. In FIG. 4(b), part A of Symbol 1 is the time redundant part and part B is the part that is used to derive part A. In such case, Antenna 1 receives part A of Symbol 1 and then the system switches to Antenna 2. Once again, it is to be noted that Antenna 2 may be switched on at anytime between time t1 and t2. Antenna 2 then receives part B of Symbol 1 and part A of Symbol 2. Similarly system may switch to Antenna 3 at anytime between time t3 and t4. Phase difference between part A of Symbol 1 received by Antenna 1 and part B of Symbol 1 received by Antenna 2 gives the phase difference between Antenna 1 and Antenna 2. The value of phase difference in combination with knowledge of the separation between antennas 1 and 2 may be used to estimate the DoA of the radio signal. Similarly, phase difference between part A of symbol 2 received by antenna 2 and part B of symbol 2 received by antenna 3 may be used to determine the phase difference between antennas 2 and 3. This value of phase difference in combination with knowledge of the spacing between antennas 2 and 3 may be used to estimate the DoA of the radio signal.

The estimate of DoA obtained using Symbol 1 and antennas 1 and 2 may be combined with the estimate of DoA obtained using Symbol 2 and antennas 2 and 3 to arrive at a more reliable estimate of DoA using, for example, an averaging operation.

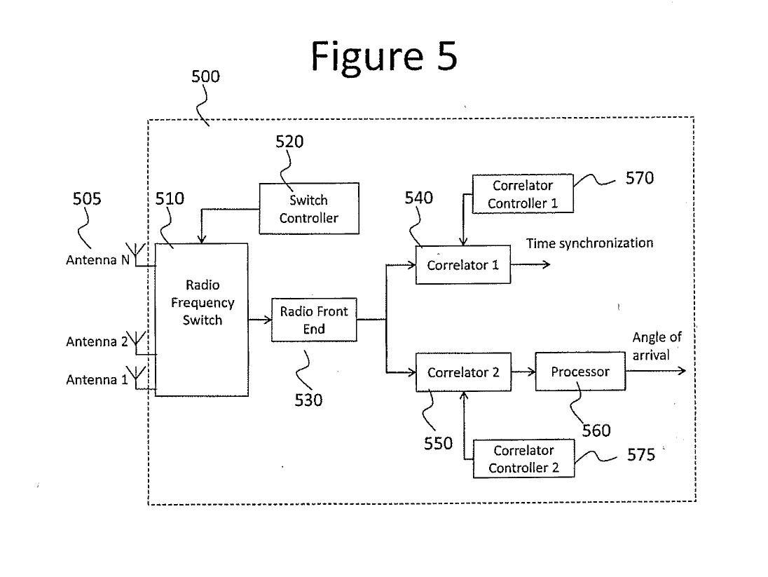

FIG. 5 shows an apparatus 500 for estimating direction of arrival of a radio signal according to an embodiment of the invention. A plurality of antennas 505 are coupled to apparatus 500. Apparatus 500 comprises a radio frequency switch 510 that is controlled by a switch controller 520. The radio frequency switch 510 is coupled to radio front end 530. Radio front end 530 is further coupled to correlator 1 540 and correlator 2 550. Operations of correlator 1 are controlled by correlator controller 1 570 and operations of correlator 2 are controlled by correlator controller 2 575. Correlator 2 is further coupled to processor 560.

In an example embodiment, a radio signal is received by a plurality of antennas 505. The antennas 500 may be arranged equally spaced and along a line, as shown in FIG. 2. The radio signal may comprise an OFDM symbol such as one shown in FIG. 3. The radio frequency switch 510 determines which of the antennas 500 gets coupled to radio front end 530. The operation of the radio frequency switch 510 is controlled by switch controller 520. The switch controller 520 may provide switching pattern to the radio frequency switch 510 for switching between antennas or the switching pattern may be stored a-priori in the radio frequency switch 510. In an example embodiment of the invention, the switching pattern comprises starting with Antenna 1 and then switching to Antenna 2, switching back to Antenna 1 and then switching to Antenna 3, switching back to Antenna 1 and then switching to Antenna 4 and continuing this pattern till antenna N is coupled to the radio front end and finally switching back to Antenna 1. This pattern may be succinctly written as “Antenna 1-Antenna 2-Antenna 1-Antenna 3-Antenna 1- . . . -Antenna N-Antenna 1”. In another example embodiment of the invention, switching between antennas is done such that time redundant portion of a radio signal and portion of the radio signal that was used to construct the time redundant portion are received by different antennas, as shown in FIG. 4.

Radio front end 530 receives analog radio frequency signal from the radio frequency switch 510 and downconverts it to digital baseband form to feed to the correlators 540 and 550. The radio front end 530 may comprise a direct conversion receiver for demodulating the radio signal received by the antennas followed by analog-to-digital converters. The radio front end 530 may further comprise a low noise amplifier to amplify the radio signal received from the antennas, a frequency down conversion unit for converting a signal from radio frequency to baseband signal and analog baseband circuitry. The analog baseband circuitry may further comprise low pass filters, baseband amplifiers and analog to digital converters. The radio front end may also comprise a band selection filter to isolate signals in a certain frequency band.

Radio front end 530 feeds the signals to both Correlator 1 540 and Correlator 2 550. The operations of Correlator 1 540 and Correlator 2 550 are controlled by the Correlator Controller 1 570 and Correlator Controller 2 575, respectively. Correlator 1 540 performs time synchronization on the received signal. In an example embodiment of the invention, time synchronization may be achieved by performing autocorrelation operation on a baseband signal received from the radio front end 530 to obtain an estimate of the start of the baseband signal by utilizing a time redundant portion of the baseband signal. If the baseband signal comprises an OFDM symbol such as one shown in FIG. 3, then a symbol timing estimate may be obtained by exploiting the time domain redundancy present in the OFDM symbol in form of a cyclic prefix. Correlator 1 540 may compute autocorrelation of the received samples with timing offset values ranging from 1-80. Since the cyclic prefix is located in samples 1-16 and is a copied version of samples 65-80 in the symbol, a sudden increase in the value of autocorrelation is expected when the timing offset is such that the cyclic prefix of an OFDM symbol lines up against the last 16 samples of the OFDM symbol. Next symbol starts at index 80 plus the value of the timing offset. Correlator 1 540 may compute time synchronization over multiple OFDM symbols and combine them, for example using averaging operation, to arrive at a reliable estimate of time synchronization.

Radio front end 530 also feeds the baseband signals to Correlator 2 550. Correlator 2 550 correlates the baseband signal received from the radio front end 530 to obtain estimate of the phase difference between a pair of antennas. If the antennas are switched by the radio frequency switch 510 such that the OFDM symbols are received as shown in FIG. 4(a), then each OFDM symbol will be received by the antenna array such that the cyclic prefix of an OFDM symbol and the last 16 samples of the OFDM symbol from which the cyclic prefix is derived, will be received by different antennas. Considering Symbol 1 in FIG. 4(a), the cyclic prefix of Symbol 1 will be received by Antenna 1 and the last 16 samples of the OFDM symbol will be received by Antenna 2.

Correlator 2 550 may compute the value of correlation between time redundant portion of a signal received by a first antenna and the part of the signal that was used to construct the time redundant portion as received by a second antenna. In case of an OFDM symbol, such as one shown in FIG. 4(a), Correlator 2 550 will compute value of correlation between cyclic prefix and the last 16 samples of an OFDM symbol to obtain an estimate of the phase difference between the first and the second antenna. In an example embodiment of the invention, the antennas are switched in the middle of Symbol 1, for example, switching occurs after sample number 40 of an OFDM symbol has been received. In such an embodiment, Antenna 1 will receive samples 1-40 of Symbol 1 and Antenna 2 will receive samples 41-80 of Symbol 1. Correlator 2 550 may compute the phase difference between antenna 2 and antenna 1, φ_{2,1}, according to the following equation:

$${ϕ}_{2 , 1} = Angle ( {\sum }_{k = 1}^{16} {\{ Ant 2 ( 24 + k ) \}}^{*} \{ Ant 1 ( 40 + k ) \} )$$

where Ant1(i) denotes the i^{th} sample received by antenna 1, Ant2(i) denotes the i^{th} sample received by antenna 2, {.}* denotes the complex conjugate operation, Angle(.) denotes the phase or the angle operator and k is a dummy variable used as index for summation. The above equation may be succinctly written as

φ_{2,1}=Angle(U^{H}V)

where U denotes a column vector comprising samples 25-40 received by antenna 2, V denotes a column vector comprising samples 41-56 received by antenna 1 and U^{H} is complex-conjugate transpose of the column vector U.

Correlator 2 550 feeds the phase difference between two antennas to the processor 560 which computes the angle of arrival of a radio signal. In an example embodiment of the invention, the DoA, θ, of the radio signal at antenna 1 and antenna 2 separated by distance d, φ_{2,1}, the phase difference between antenna 2 and antenna 1, is given by:

$$θ = {Cos}^{- 1} ( \frac{{ϕ}_{2 , 1}}{2 π d / λ} )$$

where λ is the wavelength of the radio signal.

In another example embodiment of the invention, processor 560 may combine estimates of angle of arrival from multiple antenna pairs to obtain a more reliable estimate of the angle of arrival. If there are in antenna pairs, the processor may combine the estimates from each of the antenna pairs as:

$$θ = {Cos}^{- 1} ( \frac{\sum ϕ}{2 π m d / λ} )$$

where Σφ is the sum of the estimates of angle of arrival obtained using each of the m antenna pairs.

In yet another embodiment of the invention, if frequency offset is present between antennas, the antennas are switched using the following pattern: Antenna 1-Antenna 2-Antenna 1-Antenna 3-Antenna 1- . . . -Antenna N-Antenna 1. Frequency offset between antennas results in a constant phase change between antennas and this switching pattern enables frequency offset canceling between two antennas. For example, the phase difference calculated by switching from Antenna 1 to Antenna 2 is given as φ(θ)+φ(Δf), where φ(θ) is the component of the phase difference dependent on the angle of arrival and φ(Δf) is the component of phase difference that is caused by the frequency offset between Antenna 1 and Antenna 2. Similarly, switching from Antenna 2 to Antenna 1 will result in a phase difference equal to −φ(θ)+φ(Δf). Subtracting the two phase differences results in φ(θ)+φ(Δf)−(−φ(θ)+φ(Δf))=2φ(θ), which is independent of the frequency offset between the antenna 1 and antenna 2. The same process is repeated for the other antenna pairs by following the switching pattern. It should be noted that in this embodiment, DoA estimation requires 2N−1 OFDM symbols after timing synchronization has been achieved.

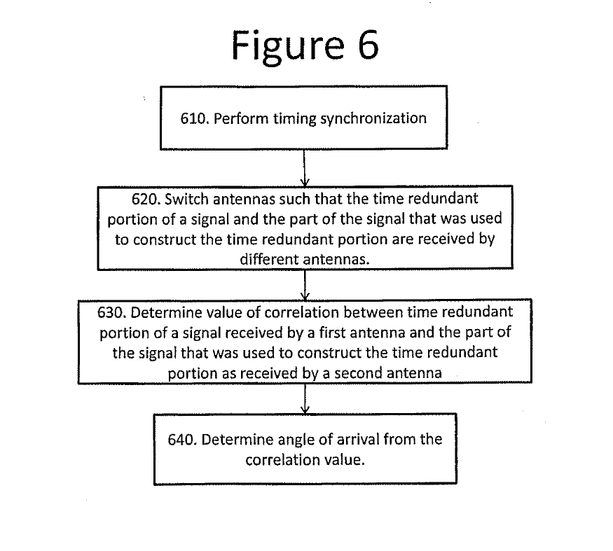

FIG. 6 is a flowchart for showing operation for estimating direction of arrival according to an example embodiment of the invention.

At block 610, the apparatus performs timing synchronization. In an example embodiment, timing synchronization is the process of estimating start of radio signal. In OFDM signaling, timing synchronization may imply determining start of an OFDM symbol. If the system utilizes time redundancy on a per frame basis, then timing synchronization may imply determining the start of a frame. In general, timing synchronization may imply determining start of a block of data that utilizes time domain redundancy.

At block 620, antenna switching is employed such that the time redundant portion of the block of data and the part of the block of data that was used to construct the time redundant portion, are received by different antennas. For example in FIG. 4 (a), antenna switching is employed such that cyclic prefix of an OFDM symbol and the samples of the OFDM symbol that were used to derive the cyclic prefix are received by different antennas.

At block 630, the apparatus determines value of correlation between time redundant portion received by a first antenna and the part of the signal from which the time redundant portion was constructed as received by a second antenna.

At block 640, the apparatus determines the angle of arrival of the radio signal based at least in part on the value of correlation determined at block 630.

Without in any way limiting the Scope, interpretation, or application of the claims appearing below, a technical effect of one or more of the example embodiments disclosed herein is estimation of direction of arrival of a radio signal. Another technical effect of one or more of the example embodiments disclosed herein is estimation of direction of arrival of a radio signal comprising a time redundant portion. Another technical effect of one or more of the example embodiments disclosed herein is estimation of direction of arrival of a radio signal comprising OFDM symbols.

Embodiments of the present invention may be implemented in software, hardware, application logic or a combination of software, hardware and application logic. The software, application logic and/or hardware may reside on radio receiver. If desired, part of the software, application logic and/or hardware may reside on radio frequency switch, part of the software, application logic and/or hardware may reside on radio front end, and part of the software, application logic and/or hardware may reside on a correlator. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-26. (canceled)

27. An apparatus, comprising:
a receiver configured to receive a first portion of a radio signal comprising a time redundant portion received at a first antenna and a second portion of the radio signal received at a second antenna;
a correlator configured to determine a value of correlation between the first portion and the second portion; and
a processor configured to estimate direction of arrival of the radio signal based at least in part upon the value of correlation.

28. The apparatus of claim 27, wherein the time redundant portion of the radio signal is obtained by attaching a part of the radio signal to itself.

29. The apparatus of claim 27, wherein the time redundant portion of the radio signal is derived from the second portion of the radio signal.

30. The apparatus of claim 27, wherein the processor is further configured to estimate phase difference between the first and the second antenna based upon an angle of the value of correlation.

31. The apparatus of claim 27, wherein the estimate of direction of arrival is combined with estimates of direction of arrival obtained by using a plurality of antenna pairs using averaging operation.

32. The apparatus of claim 27, wherein the processor is further configured to determine an angle of correlation as
φ=Angle(U^{H}V),
where U denotes a column vector comprising time redundant samples contained in the first portion of the radio signal, V denotes a column vector comprising samples contained in the second portion of the radio signal from which U is derived, U^{H} is complex-conjugate transpose of the column vector U, and Angle(U^{H}V) denotes angle of complex number U^{H}V.

33. The apparatus of claim 27, wherein the processor is configured to estimate the direction of arrival as:
$$θ = {Cos}^{- 1} ( \frac{\sum ϕ}{2 π k d / λ} ) ,$$
wherein Σφ is sum of phase difference between k antenna pairs, d is distance between each of the antenna pairs and λ is wavelength of the radio signal.

34. The apparatus of claim 27, further comprising:
a plurality of antennas, antenna 1, antenna 2, . . . , antenna N; and
a radio frequency switch configured to switch the antennas in the following order:
antenna 1-antenna 2-antenna 1-antenna 3-antenna 1- . . . -antenna N-antenna 1.

35. The apparatus of claim 27, further comprising a radio frequency switch configured to switch antennas such that the time redundant portion of the radio signal and a part of the radio signal that was used to construct the time redundant portion are received by different antennas.

36. A method, comprising:
determining correlation between a first portion of a radio signal comprising a time redundant portion received at a first antenna and a second portion of the radio signal received at a second antenna; and estimating direction of arrival of the radio signal based at least in part on the correlation.

37. The method of claim 36, wherein the time redundant portion of the radio signal is obtained by attaching a portion of the radio signal to itself.

38. The method of claim 36, wherein the time redundant portion of the radio signal is derived from the second portion of the radio signal.

39. The method of claim 36, further comprising estimating phase difference between the first and the second antenna based upon an angle of the correlation.

40. The method of claim 36, further comprising:
forming multiple antenna pairs from a group of antennas not comprising the first antenna and the second antenna;
forming an estimate of the direction of arrival of the radio signal based upon each antenna pair; and
determining a joint estimate of the direction of arrival by averaging the estimate of direction of arrival obtained using the first antenna and the second antenna with estimates corresponding to each antenna pair.

41. The method of claim 36, wherein an angle of correlation is computed as
φ=Angle(U^{H}V),
wherein U denotes a column vector comprising samples from the time redundant portion of the radio signal, V denotes a column vector comprising samples contained in the second portion of the radio signal from which U is derived, U^{H} is complex-conjugate transpose of the column vector U, and Angle(U^{H}V) is angle of complex number U^{H}V.

42. The method of claim 36, wherein the direction of arrival is computed as:
$$θ = {Cos}^{- 1} ( \frac{\sum ϕ}{2 π k d / λ} ) ,$$
wherein Σφ is sum of phase difference between k antenna pairs, d is distance between two antennas of each pair and λ is wavelength of the radio signal.

43. The method of claim 36, further comprising
switching a plurality of antennas, antenna 1, antenna 2, . . . , antenna N, in the following order: antenna 1-antenna 2-antenna 1-antenna 3-antenna 1- . . . -antenna N.

44. The method of claim 43, further comprising switching between the plurality of antennas such that the time redundant portion of the radio signal and portion of the radio signal that was used to construct the time redundant portion are received by different antennas.

45. An apparatus, comprising:
at least one processor; and
at least one memory including computer program code
the at least one memory and the computer program code configured to, with the at least one processor, cause the apparatus to perform at least the following:
determine correlation between a first portion of a radio signal comprising a time redundant portion received at a first antenna and a second portion of the radio signal received at a second antenna; and estimate direction of arrival of the radio signal based at least in part on the correlation.

46. A computer-readable medium encoded with instructions that, when executed by a computer, perform:
determine correlation between a first portion of a radio signal comprising a time redundant portion received at a first antenna and a second portion of the radio signal received at a second antenna; and estimate direction of arrival of the radio signal based at least in part on the correlation.
